(19) United States
(12) Patent Application Publication
(10) Pub. No.: US 2026/0308431 A1
(43) Pub. Date: Oct. 8, 2026

(54) CURABLE COMPOSITION

(71) Applicant: Evonik Operations GmbH, Essen (DE)

(72) Inventors: Nicolai KOLB, Marl (DE); Alexander EL AZZAWI, Bochum (DE); Laura BORG, Recklinghausen (DE)

(73) Assignee: Evonik Operations GmbH, Essen (DE)

(21) Appl. No.: 19/481,297

(22) PCT Filed: May 10, 2024
(86) PCT No.: PCT/EP2024/062896

§ 371 Date: Nov. 4, 2025

(30) Foreign Application Priority Data
May 11, 2023 (EP) 23172812.2

(51) Int. Cl. C09J 175/06; C09J 5/00; C09J 11/04

(52) U.S. Cl. CPC C09J 175/06; C09J 5/00; C09J 11/04

(57) ABSTRACT

A curable composition containing a polymer having at least two isocyanate-reactive groups that can react with isocyanate groups, where at least one of these isocyanate-reactive groups is a CH-acidic group, and a polyfunctional isocyanate having at least one isocyanate group and an alkaline earth metal organyl catalyst.

Adhesives form the backbone of modern joining processes and joining technologies. They are highly efficient, as they are capable of bonding a very wide variety of materials in a force-fitting manner with even a small application amount. Among the countless different types of adhesives and adhesive technologies, polyurethane-based adhesives in particular are suitable for a multitude of applications and, on account of their chemical structure, are suitable for numerous different forms of adhesive, for example reactive hot-melt adhesives, 2-component adhesives or dispersion adhesives.

Similarly to other reactive adhesive systems such as epoxy or silicone adhesives, the polyurethane-based adhesives are suitable for applications with the highest demands, as they form very durable and highly stable joints that typically withstand all external challenges (weathering, heat and cold, humidity, etc.).

However, in the context of sustainability considerations, there are discussions that joined components (bonded products) be recycled again at the end of the life cycle, or that they be separable for the purpose of repairs without causing serious damage to the components, for example in electronic devices such as mobile telephones or displays. For such recycling or separation, the adhesive had to be separable “on demand” (De-Bonding on Demand, abbreviated to DoD).

A customary approach for De-Bonding on Demand is the introduction of temperature, as a result of which the adhesion and/or the cohesion are influenced. There are various approaches in this regard, for example the addition of a non-reactively incorporated resin into the adhesive formulation, which resin “softens” the adhesive at temperatures above the softening point and correspondingly lowers the cohesion (WO2016/000222). However, this approach is disadvantageous since the non-reactively incorporated polymers usually lead to a lower cohesion of the adhesive even at lower temperatures during the phase/period of use. They may impair the chemical resistance, be washed out or lead to undesired migration.

Macromolecules, 2018, 51 (3), pages 660-669, describes the reaction product of an acetoacetoxyacrylic ester as CH-acidic component with an isocyanate for obtaining a thermolabile, radiation-crosslinkable crosslinker which makes radiation-curing adhesive separable on demand (by the action of heat). Malonates are also suitable as CH-acidic component for the reaction with isocyanates, for example in the form of malonate-containing polyesters as described in U.S. Pat. No. 4,006,122.

The use of malonate-containing polyesters for the production of adhesive systems having thermal stability is described in EP3636687A1. In this document, blends of malonate-containing polyesters with isocyanate-terminated polyesters were prepared and the heat resistance was then analysed. The reaction of malonate-containing polyester with isocyanate was effected with the aid of a catalyst, zinc (II) acetylacetonate.

US 2018/282575A1 discloses curable coating compositions including: a polymer including at least two active methylene functional groups; a polyisocyanate crosslinker; and a transition metal catalyst (barium sulfate and magnesium silica hydrate). Substrates at least partially coated with these coating compositions are further disclosed.

U.S. Pat. No. 4,006,122A discloses poly (ester amides), which are obtained by heating a hydroxyl-containing or hydroxyl-free polyester of malonic acid with an organic polyisocyanate in the presence of a basic catalyst (calcium acetate). Crosslinking of the polyester takes place by reaction of the isocyanate with the active hydrogen of the CH2 group of the malonate to give amide linkages.

U.S. Pat. No. 5,714,563A discloses a curable composition comprising an acetoacetate functional compound and a polyisocyanate functional compound in the presence of calcium oxide.

The comparatively inert reactivity of the CH-acidic compounds with respect to isocyanates compared to the reaction of hydroxyl compounds with isocyanates was a disadvantage in all of the reactions described. In some cases, no complete conversions were obtained or a catalyst or equimolar amounts of highly reactive reagents such as sodium hydride or elemental sodium had to be used in order to obtain a complete conversion. This leads to serious safety-related challenges and can lead to numerous side reactions such as hydrolysis of ester bonds.

Accordingly, an object of the present invention was that of providing a reaction system which ensures a rapid reaction with as high as possible a selectivity for the target product and also low safety-related challenges of CH-acidic components with isocyanates.

The object is achieved with a curable composition containing
a) a polymer having at least two isocyanate-reactive groups, wherein at least one of these isocyanate-reactive groups is a CH-acidic group,
b) a polyfunctional isocyanate having at least one isocyanate group
c) from 0.005 mol % to 15 mol % of at least one alkaline earth metal organyl catalyst, based on the total molar amount of CH-acidic groups of polymer a), wherein the organyl is selected from the group of alkoxides, complexes based on 1,3-diketone, or a mixture thereof,
d) and optionally further additives, polymers, fillers,
   wherein the amount of polymer a) and the amount of polyfunctional isocyanate b) used is chosen in such a way that the molar ratio of isocyanate-reactive groups of polymer a) to the isocyanate groups of the polyfunctional isocyanate b) is from 10:1 to 1:10.

In the context of the present invention, the term “isocyanate-reactive groups” means some reactive groups that can react with isocyanate groups (NCO groups).

Therefore, an aspect of the present invention is compositions as defined in the claims and also in the following description.

Another aspect of the present invention is a method for preparing the compositions according to the invention as defined in the claims and in the following description.

Yet another aspect of the present invention is the use of the compositions according to the invention for the bonding of substrates and also as adhesive/sealant or coating material.

The compositions according to the invention have the advantage that a complete reaction and curing of the isocyanates with the CH-acidic components can be achieved, no safety-critical catalysts need to be used and the resulting cured systems are preferably de-bonded at temperatures of less than 250° C.

The curable compositions according to the invention, the method according to the invention for preparing same and the use according to the invention of the curable compositions are described hereinafter by way of example without the intention of limiting the invention to these exemplary embodiments.

Where figures are given in percent hereinafter, these are percentages by weight unless otherwise stated. Where average values, for example molar mass average values, are specified hereinafter, these are the numerical average unless stated otherwise. Where properties of a material are specified hereinafter, for example viscosities or the like, these are the properties of the material at 25° C. unless stated otherwise.

### Component a)

Component a) is a polymer a) having at least two isocyanate-reactive groups, which can react with NCO groups (isocyanate groups), wherein at least one of these isocyanate-reactive groups is a CH-acidic group.

According to the present invention, the polymer a) corresponds to a polymer prepared by polymerizing a monomer composition comprising at least one CH-acidic compound as described below, or is the resulting product of a reaction between said CH-acidic compound with OH- and/or NH-functional polymers, as described below.

In the context of the present invention, the CH-acidic compounds should be understood to mean those compounds that by means of strong bases are able to release at least one proton from a carbon atom. Preferably, the pKa (acid strength) of the CH-acidic compound is in the range of from 5 to 20.

In addition to the proton of the CH-acidic group that can be released for the reaction with the polyfunctional isocyanate b), the CH-acidic compounds preferably also have at least one further functional group that can be used for the covalent attachment of the CH-acidic compounds to a polymer or functional molecule.

The CH-acidic compounds are preferably selected from the group consisting of malonic esters, acetoacetic esters, nitro compounds, nitriles, lactones or mixtures thereof. Usually, the proton to be released is in the alpha position of at least one functional group, such as ketone, aldehyde, nitrile, nitro, ester, halides or sulfur. Preferably, the proton to be released is in the alpha position of at least 2 such functional groups.

The CH-acidic compounds are particularly preferably malonic esters, acetoacetic esters and also mixtures thereof.

The polymer a) contains at least one CH-acidic group, preferably two or more CH-acidic groups. These can be located at the chain end of the polymer, within the polymer chain, or both at the chain end and within the polymer chain. More preferably, the polymer a) contains between 2 to 30 covalently attached CH-acidic groups.

However, the polymer a) can also contain free OH groups. Those free OH-groups can for example result from incorporating/copolymerizing polyglycols and preferably polyethylene glycols (PEGs), OH-functional polybutadienes, polyesters, polyacrylates, or hexanediols. These free OH groups can also react with isocyanates.

The polymer a) can also contain free NH groups. Those free NH groups can for example result from incorporating/copolymerizing amine-terminated polyethers (Jeffamines) or polyamides. These free NH groups can also react with isocyanates.

The exemplary preparation of polymers a) is described in patent application EP3636687A1. The preparation is preferably carried out by melt condensation of the OH- and/or NH-functional polymers with the CH-acidic compound, typically resulting in the formation of a covalent bond between the CH-acidic compound and the OH- and/or NH-functional polymers with elimination of a leaving group.

The OH- or NH-functional polymers used may be any known corresponding polymers. OH-functional compounds in the context of the present invention are preferably OH-functional or OH-terminated polymers such as polyester, polybutadiene, polyethylene glycol or polypropylene glycol and also mixtures thereof, poly-THF, polylactic acid, poly(meth)acrylates and also non-polymeric compounds such as ethylene glycol, propane-1,2-diol, trimethylene glycol, neopentyl glycol, butanediols, pentanediols, hexanediol or corresponding higher carbon analogues, glycerol, trimethylolpropane, pentaerythritol, cyclic alcohols such as cyclohexanedimethanol or dicidol and also mixtures thereof. The OH-functional polymers are particularly preferably OH-functional or OH-terminated polymers, and very particularly preferably OH-terminated polymers.

NH-functional polymers within the context of the present invention are preferably polyesteramines or amine-terminated polyamides.

The polymer a) is preferably selected from the group consisting of polyesters, polyethers, poly(meth)acrylates, polybutadienes or a mixture thereof; more preferably polyesters, polyethers or a mixture thereof; and even more preferably polyesters or a mixture thereof.

The polymer a) of the curable composition is preferably a polymer having a number-average molecular weight from 500 to 50 000 g/mol according to DIN 55672-1, or a mixture thereof. In the present invention, the number-average molecular weight of the polymers a) are determined by gel permeation chromatography (GPC) using polystyrene calibration standards according to DIN 55672-1.

### Component b)

Component b) is a polyfunctional isocyanate having at least one isocyanate group (NCO group).

The component b) of the curable composition is a polyfunctional isocyanate having at least one NCO group. Preferably, the polyfunctional isocyanate b) is selected from the group consisting of diisocyanates, triisocyanates, isocyanate-(meth)acrylates, isocyanatosilanes or mixtures thereof.

Preferred isocyanatosilanes are 3-(trimethoxysilyl) propyl isocyanate and 3-(triethoxysilyl) propyl isocyanate.

In the context of the present invention, polyfunctional isocyanates can be compounds that bear at least one isocyanate group and a further polymerizable functional group and also compounds that have at least two isocyanate groups. The polyfunctional isocyanates are preferably di- or triisocyanates such as diphenylmethane 2,2′-diisocyanate, diphenylmethane 2,4′-diisocyanate, diphenylmethane 4,4′-diisocyanate, tolylene 2,4-diisocyanate, tolylene 2,6-diisocyanate, isophorone diisocyanate, pentamethylene diisocyanate, hexamethylene diisocyanate, 2,4,4-trimethylhexamethylene diisocyanate and also derivatives formed therefrom such as uretdiones and isocyanurates or mixtures thereof. Particularly preferably, the polyfunctional isocyanates are diisocyanates, most preferably diphenylmethane 2,2′-diisocyanate.

According to the present invention, the amount of polymer a) and the amount of polyfunctional isocyanate b) used in the curable composition according to the invention is chosen in such a way that the molar ratio of isocyanate-reactive groups of the polymer a) to the isocyanate groups of the polyfunctional isocyanate b) is from 10:1 to 1:10, preferably from 8:1 to 1:8, more preferably 5:1 to 1:5.

### Component c)

Component c) is at least one alkaline earth metal organyl catalyst.

The composition according to the invention contains from 0.005 mol % to 15 mol %, preferably from 0.01 mol % to 10 mol %, more preferably from 0.02 mol % to 5 mol %, even more preferably from 0.05 mol % to 3 mol %, of at least one alkaline earth metal organyl catalyst, based on the molar amount of CH-acidic groups of polymer a), wherein the organyl is selected from the group of alkoxides, complexes based on 1,3-diketones, or a mixture thereof.

The alkaline earth metal organyl catalyst c) is preferably selected from the group consisting of calcium, magnesium or strontium organyls or mixtures thereof, more preferably from the group consisting of alkoxides of calcium, alkoxides of magnesium, alkoxides of strontium, complexes of 1,3-diketones with calcium or magnesium or strontium, or a mixture thereof.

Preferred complexes based on 1,3-diketones are acetylacetonate and derivatives thereof. More preferably, the complexes based on 1,3-diketones are selected from the group consisting of acetylacetonate, 2,2,6,6-tetramethyl-3,5-heptanedione or a mixture thereof.

Particularly preferred alkoxides are selected from the group of methoxide, ethoxide, propoxide, butoxide, 1,2-ethylene glycol alkoxide, propane-1,2-diol alkoxide, propane-1,3-diol alkoxide, butane-1,2-diol alkoxide, butane-1,3-diol alkoxide, butane-1,4-diol alkoxide, butane-2,3-diol alkoxide and neopentyl alkoxide or a mixture thereof.

Most preferred alkaline earth metal organyl catalysts c) are chosen from the group consisting of calcium methoxide, magnesium methoxide, strontium methoxide, calcium ethoxide, magnesium ethoxide, strontium ethoxide, magnesium acetylacetonate, calcium acetylacetonate, strontium acetylacetonate, bis(2,2,6,6-tetramethyl-3,5-heptanedionato) calcium, bis(2,2,6,6-tetramethyl-3,5-heptanedionato) magnesium, bis(2,2,6,6-tetramethyl-3,5-heptanedionato) strontium, strontium isopropoxide, or a mixture thereof.

### Optional Component d)

Component d) corresponds to further additives, polymers, and/or fillers.

The curable composition according to the invention may consist of components a), b) and c); however, it can also contain further components. In particular, further polymers, but also additives and/or fillers, can be present in the curable composition.

“Further polymers” means polymers different from the polymers a). Preference is given to adding further OH- or NH-functional polymers without any CH-acidic functional groups, which may ensure curing with the polyfunctional isocyanate and possibly adjust thermal stability.

Moreover, it is possible to add up to 50% by weight, preferably 5% to 40% by weight, based on the total weight of the curable composition, of further additions, in particular additives, which by way of example ensure improved hydrolysis stability. These additions may be, for example: non-functionalized polymers, for example thermoplastic polyurethanes (TPUs) and/or polyacrylates and/or ethylene-vinyl acetate copolymers (EVA); pigments or fillers, for example talc, silicon dioxide, titanium dioxide, barium sulfate, calcium carbonate, carbon black or colour pigments; tackifiers, for example rosins, hydrocarbon resins, phenolic resins, and ageing stabilizers and auxiliaries.

### Method for Preparing a Curable Composition

There are various methods for preparing the curable composition. The most common method is mixing. The mixing is preferably carried out at room temperature or higher, preferably at a temperature of greater than 30° C., more preferably at a temperature from 50 to 130° C. and most preferably at a temperature from 70 to 110° C. Depending on the nature of the adhesive to be produced, the mixing can be carried out in the melt or in a solvent or water.

It may be advantageous to conduct the mixing under a protective gas atmosphere, for example preferably under an inert gas or nitrogen atmosphere. This makes it possible to avoid unwanted reactions.

The mixing is preferably conducted over a period of from 0.1 to 360 minutes, more preferably 15 to 180 minutes.

### Use of the Curable Compositions According to the Invention

The compositions according to the invention can be used for the bonding of substrates, preferably used as adhesive, sealant or coating material. The bonding preferably involves a bond which is separable (de-bondable) after curing by heat treatment at a temperature from 50 to 250° C., more preferably from 90 to 200° C., even more preferably from 110 to 190° C. and most preferably from 110 to 170° C.

The compositions according to the invention are particularly suitable for the production of bonds of a variety of substrates, for example plastics, fibre-reinforced plastics, metals, types of wood, glass, glass-ceramic, concrete, mortar, brick, stone, foams, paper, cardboard, especially for the bonding of metallic substrates, textiles, and various plastics.

The nature and the extent of the bonding are not limited. Preferably, the bonds are bonds in the wood and furniture industry (for example assembly bonding and the lamination of decorative films onto fibreboards), in the automotive and transport sector (for example laminations of films or textiles onto door side parts, inner roof linings, seat manufacture, retainer bonds, assembly bonds and also the manufacture of sandwich elements), in the electronics industry, construction industry (for example for the manufacture of panels and doors), in the shoe industry, in the graphics industry and in the textile industry, and in window construction (for example for profile sheathing). In addition, the compositions according to the invention are suitable in the packaging industry, as sealants and as coating material.

The compositions according to the invention are suitable both for use in one-component systems and in two-component systems.

In the case of one-component adhesives, the mixture is produced at a time independent of the adhesive application, typically at a much earlier time. The application of the adhesive according to the invention is followed by curing, for example by moisture or by thermally induced reaction of the co-reactants present in the adhesive. In the case of two-component adhesives, the mixture is produced directly prior to adhesive application.

The adhesive formulations (compositions) according to the invention can be applied by all known methods, for example extruder, bead, nozzle, spreading, dipping, injecting, pouring, rolling, spraying, printing, wiping, washing, tumbling, centrifuging, powder (electrostatic).

### EXAMPLES

The preferred embodiments and examples are to be interpreted merely as a descriptive disclosure which is by no means limiting in any way whatsoever.

The subject matter of the present invention is elucidated in more detail in the examples which follow, without any intention that the subject matter of the present invention be restricted to these.

### Test Methods:

### 1. ATR Infrared Spectroscopy

The decrease in free isocyanate was analysed qualitatively by means of ATR-IR (Alpha II from Bruker) in samples taken over the course of the reaction.

### 2. Molecular Weight Distribution

The number-average molecular weight of the polyesters used in the examples is determined in accordance with DIN 55672-1 by means of gel permeation chromatography in tetrahydrofuran as eluent and polystyrene for calibration.

### Evaluation of Catalysts:

General procedure: A Radleys™ 20 mL reaction tube was filled at room temperature with a defined amount of catalyst and then dimethyl malonate, in this order. The reaction tube was purged with nitrogen and then a defined amount of phenyl isocyanate was added. The mixture was then stirred for the specified time and temperature and analysed for residual NCO after the reaction time was complete.

To rate the activity of catalysts, qualitative ATR-IR measurements were used for the rating as follows:

| NCO band signal (approx. 2250 cm⁻¹) | Rating |
|---|---|
| NCO band no longer visible | ++ |
| NCO band visible only in traces | + |
| NCO band clearly visible but decreased compared to | 0 |
| blank sample | |
| NCO band not markedly decreased compared to the blank | − |
| sample/no reaction detectable | |

### Experiment Series 1:0.36 g of Phenyl Isocyanate (3 Mmol), 1.98 g of Dimethyl Malonate (15 Mmol), 10 Mol % of Catalyst, Reaction Time 2 Hours

| | | Weight of | Activity | Activity | Activity | Activity |
|---|---|---|---|---|---|---|
| Experi- | | catalyst | @ | @ | @ | @ |
| ment | Catalyst | [mg] | 30° C. | 50° C. | 70° C. | 90° C. |
| 1-0 | none | none | − | − | − | − |
| 1-1 | NaOMe | 16.2 | ++ | ++ | ++ | ++ |
| 1-2 | KOMe | 21.0 | ++ | ++ | ++ | ++ |
| 1-3 | KOtBu | 33.7 | ++ | ++ | ++ | ++ |
| 1-4 | Al(OtBu)₃ | 73.9 | − | − | − | − |
| 1-5 | Ti(OBu)₄ | 102.1 | − | − | − | 0 |
| 1-6 | Mg(OEt)₂ | 34.3 | − | 0 | ++ | ++ |
| 1-7 | Ca(OMe)₂ | 30.6 | ++ | ++ | ++ | ++ |
| 1-8 | Zn(OMe)₂ | 38.2 | − | 0 | ++ | ++ |
| 1-9 | Zn(acac)₂ | 79.1 | − | − | − | + |
| 1-10 | TiO(acac)₂ | 78.6 | − | − | 0 | ++ |
| 1-11 | Al(OH)₃ | 23.4 | − | − | − | − |

Conclusion: It was found that some catalysts do not display any reaction despite the large molar excess of dimethyl malonate with respect to the isocyanate. A few catalysts exhibit a temperature-dependent activity, for example in experiment series 1-5, 1-6 or 1-10. The catalysts of the experiment series 1-1, 1-2, 1-3 and 1-7 display outstanding activity at all temperatures under the given conditions.

### Experiment Series 2:0.60 g of Phenyl Isocyanate (5 Mmol), 1.32 g of Dimethyl Malonate (10 Mmol), 5 Mol % of Catalyst, Reaction Time 2 Hours

| | | Weight of | Activity | Activity | Activity | Activity |
|---|---|---|---|---|---|---|
| Experi- | | catalyst | @ | @ | @ | @ |
| ment | Catalyst | [mg] | 30° C. | 50° C. | 70° C. | 90° C. |
| 2-1 | NaOMe | 13.5 | ++ | ++ | ++ | ++ |
| 2-2 | KOMe | 17.5 | 0 | 0 | + | ++ |
| 2-3 | KOtBu | 28.1 | 0 | 0 | + | ++ |
| 2-4 | Mg(OEt)₂ | 28.6 | − | 0 | + | ++ |
| 2-5 | Ca(OMe)₂ | 25.5 | + | ++ | ++ | ++ |
| 2-6 | Zn(OMe)₂ | 31.9 | − | − | 0 | ++ |
| 2-7 | TiO(acac)₂ | 65.5 | − | − | − | − |

Conclusion: In the second experiment series, it was found that, with a markedly lower excess of malonate to isocyanate and a lower catalyst loading, only the catalysts of experiment series 2-1 and 2-5 have a high activity over the whole temperature range. The catalysts of the experiment series 2-2, 2-3, 2-4 and 2-6 are temperature dependent, and 2-7 displays no activity.

### Experiment Series 3:0.60 g of Phenyl Isocyanate (5 Mmol), 0.79 g of Dimethyl Malonate (6 Mmol), 2 Mol % of Catalyst, Reaction Time 4 Hours

| | | Weight of | Activity | Activity | Activity | Activity |
|---|---|---|---|---|---|---|
| Experi- | | catalyst | @ | @ | @ | @ |
| ment | Catalyst | [mg] | 30° C. | 50° C. | 70° C. | 90° C. |
| 3-1 | NaOMe | 5.4 | 0 | | 0 | + |
| 3-2 | KOtBu | 11.2 | − | | − | − |
| 3-3 | Mg(OEt)₂ | 11.4 | − | | 0 | 0 |
| 3-4 | Ca(OMe)₂ | 10.2 | 0 | | ++ | ++ |

Conclusion: With virtually equimolar ratios and a lower catalyst amount of 2 mol %, it is found that at higher temperatures only the catalyst from experiment series 3-4 has a very high activity, all other candidates exhibit significant amounts of residual isocyanate. At low temperatures, all catalysts fail to achieve a complete reaction. This shows that the catalyst calcium methoxide has a significantly higher activity compared to the other catalysts.

### Experiment Series 4:0.60 g of Phenyl Isocyanate (5 Mmol), 0.79 g of Dimethyl Malonate (6 Mmol), 2 Mol % of Catalyst, Reaction Time 4 Hours

| | | Weight of | Activity @ |
|---|---|---|---|
| Experiment | Catalyst | catalyst [mg] | 70° C. |
| 3-4 (Comp.) | Ca(OMe)₂ | 10.2 | ++ |
| 4-1 | Ca(acac)₂ | 23.8 | ++ |
| 4-2 | Sr(OiPr)₂ | 20.6 | + |

Conclusion: It is clearly apparent that both calcium acetylacetonate and strontium isopropoxide, as further representatives of alkaline earth metal catalysts, have a higher reactivity than comparable alkali metal catalysts (experiment series 3).

### Experiment Series 5:1.27 g of Hexyl Isocyanate (10 Mmol), 1.69 g of Dimethyl Malonate (12 Mmol), 1 Mol % of Catalyst, Reaction Time 4 Hours

| | | Weight of | Activity @ |
|---|---|---|---|
| Experiment | Catalyst | catalyst [mg] | 70° C. |
| 5-0 | none | none | − |
| 5-1 | NaOMe | 13.5 | + |
| 5-2 | KOMe | 17.5 | 0 |
| 5-3 | KOtBu | 28.1 | + |
| 5-5 | Ca(OMe)₂ | 25.5 | ++ |
| 5-6 | Zn(OMe)₂ | 31.9 | − |
| 5-7 | Ca(acac)₂ | 23.8 | 0 |
| 5-8 | Sr(OiPr)₂ | 20.6 | ++ |

Conclusion: Even with fundamentally less-reactive systems such as aliphatic isocyanates, alkaline earth metal catalysts, in particular the alkoxides of alkaline earth metals, display a significantly higher reactivity compared to other catalysts.

Experiment 6: Preparative Production of the Reaction Adduct of Phenyl Isocyanate with Dimethyl Malonate

In a 20 mL reaction tube, catalyst (5 mol %), 1.19 g of phenyl isocyanate (10 mmol) and 1.32 g of dimethyl malonate (10 mmol) are weighed in under nitrogen. The mixture is then heated to 70° C. for 2 hours under reflux.

Analysis by means of ATR-IR shows no remaining NCO bands, meaning that a complete reaction of the phenyl isocyanate could be confirmed.

¹H NMR analysis of the unpurified reaction mixture shows both the desired product and side reactions such as trimerized phenyl isocyanate. The proportion of unreacted dimethyl malonate compared to product indicates the selectivity of the reaction, with a minimal proportion of remaining dimethyl malonate of course being desirable.

| | | Weight of | Mol of dimethyl malonate/ |
|---|---|---|---|
| Experiment | Catalyst | catalyst | mol of product |
| 6-1 | KOtBu | 56.2 | 1.5 |
| 6-2 | Mg(OEt)₂ | 57.3 | 0.6 |
| 6-3 | Ca(OMe)₂ | 51.1 | 0.2 |

Conclusion: It is clearly apparent that alkoxides of alkaline earth metals have a considerably higher selectivity in the reaction of CH-acidic compounds with isocyanates for the desired target product and that accordingly the isocyanate enters into fewer side reactions.

Experiment Series 7: Reaction of Malonic Ester-Containing Polyesters with Diphenylmethane 4,4′-Diisocyanate (MDI)

Polyesters used, prepared in accordance with the prior art (EP3636687A1):
P1: Linear hexanediol adipate with malonate end groups with a number-average molecular weight=4000 g/mol; functionality=2, corresponding to 2000 mg/mmol of malonate
P2: Linear hexanediol malonate with malonate end groups with a number-average molecular weight=2100 g/mol; average functionality approx. 10, corresponding to 210 mg/mmol of malonate

### Composition 1:

50 g of polyester P1 (25 mmol of malonate) were melted at 90° C. in a 100 mL round-bottom flask with fitted mechanical stirrer, and then 25 mg of Ca(OMe)₂ as catalyst (1 mol % based on malonate) and 2.5 g of diphenylmethane 4,4′-diisocyanate (20 mmol of NCO) were added under nitrogen and the mixture was stirred for 3 hours. Analysis via ATR-IR showed no remaining isocyanate groups. A thermoplastic material was obtained.

Molar ratio CH-acidic groups of polymer a) to isocyanate groups of polyfunctional isocyanate b): 1.25:1

### Composition 2:

50 g of polyester P1 (25 mmol of malonate) were melted at 90° C. in a 100 mL round-bottom flask with fitted mechanical stirrer, and then 51 mg of Sr(OiPr)₂ as catalyst (1 mol % based on malonate) and 2.5 g of diphenylmethane 4,4′-diisocyanate (20 mmol of NCO) were added under nitrogen and the mixture was stirred for 3 hours. Analysis via ATR-IR showed no remaining isocyanate groups. A thermoplastic material was obtained.

Molar ratio CH-acidic groups of polymer a) to isocyanate groups of polyfunctional isocyanate b): 1.25:1

### Composition 3:

42 g of polyester P2 (200 mmol of malonate) were melted at 90° C. in a 100 mL round-bottom flask with fitted mechanical stirrer, and then 204 mg of Ca (OMe) 2 as catalyst (1 mol % based on malonate) and 7.5 g of diphenylmethane 4,4′-diisocyanate (60 mmol of NCO, 30% NCO based on malonate) were added and the mixture was stirred at 90° C. for 1 hour. Analysis via ATR-IR showed no remaining isocyanate groups. A highly cross-linked, insoluble material was obtained. Melting tests in an oven showed that the material could be melted at approx. 150° C.

Molar ratio CH-acidic groups of polymer a) to isocyanate groups of polyfunctional isocyanate b): 3.3:1

Conclusion: It is apparent that the reaction of CH-acidic groups with isocyanates also works well in polymeric systems and it is possible to obtain both thermoplastic systems by chain extension and thermosetting systems by crosslinking.

In the case of the thermosetting systems, it has been found that the systems can be remelted due to the thermally labile reaction products, which in conventional thermosets is possible only at extremely high temperatures, if at all.

1. A curable composition, comprising:
a polymer comprising at least two isocyanate-reactive groups, wherein at least one of the at least two isocyanate-reactive groups is a CH-acidic group,
a polyfunctional isocyanate comprising at least one isocyanate group,
from 0.005 mol % to 15 mol % at least one alkaline earth metal organyl catalyst, based on the molar amount of CH-acidic groups of polymer, wherein the organyl is selected from the group consisting of alkoxides, complexes based on 1,3-diketones, and a mixture thereof,
and optionally further additives, polymers, and/or fillers,
wherein the amount of the polymer and the amount of the polyfunctional isocyanate is such that a molar ratio of isocyanate-reactive groups of the polymer to isocyanate groups of the polyfunctional isocyanate is from 10:1 to 1:10.

2. The curable composition of claim 1, wherein the alkaline earth metal organyl catalyst is a calcium, magnesium or strontium organyl, or mixtures thereof.

3. The curable composition of claim 2, wherein the alkaline earth metal organyl catalyst is selected from the group consisting of an alkoxide of calcium, alkoxide of magnesium, alkoxide of strontium, complexes of 1,3-diketones with calcium or magnesium or strontium, and a mixture thereof.

4. The curable composition of claim 1, wherein the polyfunctional isocyanate is selected from the group consisting of diisocyanate, triisocyanate, isocyanate-(meth)acrylates, isocyanatosilanes, and a mixture thereof.

5. The curable composition of claim 1, wherein the polymer has a number-average molecular weight of from 500 to 50 000 g/mol according to DIN 55672-1.

6. The curable composition of claim 1, wherein the CH-acidic group in the polymer is at least one covalently attached malonic ester or acetoacetic ester.

7. The curable composition of claim 1, wherein the polymer comprises from 2 to 30 covalently attached CH-acidic groups.

8. The curable composition of claim 1, wherein the polymer is selected from the group consisting of polyesters, polyethers, poly(meth)acrylates, OH-functional polybutadienes and a mixture thereof.

9. The curable composition of claim 1, wherein a molar ratio of isocyanate-reactive groups of the polymer to isocyanate groups of the polyfunctional isocyanate is from 8:1 to 1:8.

10. The curable composition of claim 1, wherein an amount of the catalyst is from 0.01 mol % to 10 mol % based on the molar amount of CH-acidic groups of polymer.

11. A method for preparing the curable composition of claim 1, comprising:
mixing a polymer, a polyfunctional isocyanate, a alkaline earth metal based organyl catalyst, and optionally further additives, polymers and/or fillers at room temperature or higher to form the curable composition.

12. The method of claim 11, wherein the mixing is conducted over a period of from 0.1 to 360 minutes.

13. A sealing and adhesive compound and/or coating material, comprising the curable composition of claim 1.

14. A method of bonding substrates, comprising:
applying the curable composition of claim 1 to the substrates and contacting the substrates, thereby bonding the substrates.

15. The method of claim 14, wherein the bonding comprises a bond which is separable by heat treatment at a temperature from 50 to 250° C.

16. The curable composition of claim 7, wherein the covalently attached CH-acidic groups are malonic esters, acetoacetic esters or a mixtures thereof.

17. The curable composition of claim 1, wherein a molar ratio of isocyanate-reactive groups of the polymer to isocyanate groups of the polyfunctional isocyanate is from 5:1 to 1:5.

18. The curable composition of claim 1, wherein an amount of the catalyst is from 0.02 mol % to 5 mol %, based on a molar amount of the CH-acidic groups of the polymer.

19. The method of claim 11, wherein the mixing is at a temperature of greater than 30° C.

20. The method of claim 11, wherein the mixing is conducted over a period of from 15 to 180 minutes.
